(19) United States
(12) Patent Application Publication
(10) Pub. No.: US 2018/0142564 A1
(43) Pub. Date: May 24, 2018

(54) COMBINED TURBINE NOZZLE AND SHROUD DEFLECTION LIMITER

(71) Applicant: GENERAL ELECTRIC COMPANY, SCHENECTADY, NY (US)

(72) Inventors: MICHAEL EDMUND TAGLIERI, FRAMINGHAM, MA (US); JOHN ALAN MANTEIGA, NORTH ANDOVER, MA (US); MEGHAN MARY LENIHAN, BOSTON, MA (US); TYLER FREDERICK HOOPER, AMESBURY, MA (US)

(21) Appl. No.: 15/358,376

(22) Filed: Nov. 22, 2016

(51) Int. Cl. F01D 9/04; F01D 25/24; F01D 25/00

(52) U.S. Cl. CPC F01D 9/041; F01D 25/243; F05D 2300/605; F05D 2220/32; F01D 25/005

(57) ABSTRACT

A gas turbine engine annular turbine nozzle assembly includes airfoils extending between inner and outer band segments coaxial and circumscribed about a centerline axis. Shroud segment extends downstream from outer band segment. A middle outer flange may be between the segments and they may be integral, monolithic, and integrally formed such as by equiax, directionally solidified, or single crystal casting. Outer band segment may extend axially between arcuate forward and middle outer flanges. One or more deflection limiters on outer band segment limit amount of axial excursion at inner band segment. Limiters may include one or more outward projections respectively extending upwardly or radially outwardly from the middle outer flange. An annular outer casing surrounding the assembly includes inwardly extending inward projections at or about at axial and circumferential locations of limiters or outward projections. Assembly may include bonded together singlets.

### BACKGROUND OF THE INVENTION

### Technical Field

The present invention relates generally to gas turbine engine turbine nozzles and shrouds.

### Background Information

In a typical gas turbine engine, air is compressed in a compressor and mixed with fuel and ignited in a combustor for generating hot combustion gases. The gases flow downstream through a high pressure turbine (HPT) having one or more stages including one or more HPT turbine nozzles, shrouds, and rows of HPT rotor blades. The gases then flow to a low pressure turbine (LPT) having one or more stages of respective LPT turbine nozzles, shrouds, and LPT rotor blades. The HPT and LPT turbine nozzles include a plurality of circumferentially spaced apart stationary nozzle vanes extending radially between outer and inner bands. Each nozzle vane may have a hollow airfoil through which cooling air is flowed. Cooling air for each vane can be fed through a single spoolie located radially outwardly of the outer band of the nozzle. In some vanes subjected to higher temperatures, such as the HPT vanes for example, an impingement baffle may be inserted in each hollow airfoil to supply cooling air to the airfoil.

The turbine rotor stage includes a plurality of circumferentially spaced apart rotor blades extending radially outwardly from a rotor disk. Turbine nozzles are located axially forward of a turbine rotor stage. The turbine shrouds are located radially outward from the tips of the turbine rotor blades so as to form a radial clearance between the rotor blades and the shrouds. The shrouds are held in position by shroud hangers which are supported by flanges engaging with annular casing flanges.

The turbine nozzles, shrouds, and shroud hangers are typically formed in arcuate segments. Each nozzle segment typically has two or more vanes joined between an outer band segment and an inner band segment. Each nozzle segment and shroud hanger segment is typically supported at its radially outer end by flanges attached to an annular outer and/or inner casing. Each vane has a cooled airfoil disposed between radially inner and outer band panels which form the inner and outer bands. In some designs, the airfoil, inner and outer band portions, flange portion, and intake duct are cast together such that the vane is a single casting. In some other designs, the vane airfoils are inserted in corresponding openings in the outer band and the inner band and brazed along interfaces to form the nozzle segment.

A leakage path between the nozzle and shroud is a source of engine fuel efficiency and performance losses. The leakage path at the outer band can cause a hot hook on the case which can be a life limiting low cycle fatigue feature. During engine operation, the nozzle radially chords and it is desirable to reduce or prevent this chording. Chording of the bands can lead to interference with angel wing overlap. Angel wing elements provide sealing between hot turbine flow stream and cool cavity within the rotor. Inter-turbine seals on the engine's turbine transition duct are subject to axial excursions which should be minimized throughout all operating conditions. Chording occurs on the bands due to the high temperature at the band flowpath combating the colder temperatures on the non-flowpath sides of the bands, particularly, the flanges. Chording of the bands is bowing away from the flowpath.

Certain turbines have a cantilevered nozzle mounted and cantilevered from the outer band. Some nozzle segments are configured with multiple airfoils. Two vane designs may be referred to as doublets and three vane designs may be referred to as triplets. Doublets and triplets offer performance advantages in reducing split-line leakage flow between vane segments. However, the longer chord length of the bands and mounting structure compromises the durability of the multiple vane nozzle segments. The longer chord length causes an increase in chording and its adverse effects discussed above due to the higher displacement of the longer chord length activated by the radial thermal gradient through the band.

It is desirable to eliminate turbine leakage paths between the nozzle and shroud in order to improve engine fuel efficiency and performance. It is also desirable to reduce chording of bands or flanges and its negative effect or interference with angel wing overlap and sealing. It is desirable to reduce part count, decrease leakage, and enable the turbine case to be a simpler and lower cost configuration.

### BRIEF DESCRIPTION OF THE INVENTION

A gas turbine engine turbine nozzle assembly includes airfoils extending between annular coaxial inner and outer band segments circumscribed about a longitudinal or axial centerline axis, a shroud segment extending aft and downstream from the outer band segment, and the outer band segment and shroud segment being integral, monolithic, and integrally formed. One or more deflection limiters extending radially outwardly from the outer band segment limit amount of axial excursion at the inner band segments.

The outer band segment may extend axially between arcuate forward and middle outer flanges. The outer band segment and the shroud segment may be integrally formed by equiax, directionally solidified, or single crystal casting.

The assembly may include bonded together singlets. Each of the singlets includes one of the airfoils extending radially between arcuate inner and outer band singlet segments, the outer band singlet segment extending axially between arcuate forward and middle outer singlet flanges, the forward and middle outer singlet flanges extending radially outwardly from the outer band singlet segment, and the singlet including a shroud singlet segment extending aft and downstream from the outer band singlet segment to an aft singlet flange. The singlets may be integrally formed by equiax, directionally solidified, or single crystal casting.

The assembly includes one or more deflection limiters on the middle outer flange for limiting amount of axial excursion at the inner band segment. The one or more deflection limiters may include one or more outward projections respectively extending upwardly or radially outwardly from the middle outer flange.

In the embodiment with singlets, each of the outward projections may include two circumferentially adjacent outward complimentary portions on two circumferentially adjacent ones of the singlets and the singlets may be integrally formed by equiax, directionally solidified, or single crystal casting.

A gas turbine engine may include the assembly surrounded and supported by an annular outer casing. Inward projections may extend inwardly or radially inwardly from the casing at or about axial and circumferential locations of the deflection limiters.

The gas turbine engine may include a radially inner discourager or angel wing seal assembly sealingly disposed between an inner turbine duct and a high pressure turbine disk or rotor of the high pressure turbine upon which high pressure turbine blades are mounted. The inner turbine duct is attached to the assembly. The discourager or angel wing seal assembly includes an annular seal land extending forwardly or upstream from the inner turbine duct and is radially disposed between and in sealing relationship with aftwardly or downstream extending radially outer and inner angel wings attached to the high pressure turbine disk or rotor. The inner angel wing may be on an annular cooling plate attached to the high pressure turbine disk.

### BRIEF DESCRIPTION OF THE DRAWINGS

The subject matter which is regarded as the invention is particularly pointed out and distinctly claimed in the concluding part of the specification. The invention, in accordance with preferred and exemplary embodiments, together with further objects and advantages thereof, is described in the following detailed description taken in conjunction with the accompanying drawings in which:

FIG. 1 is a schematic view illustration of an exemplary aircraft gas turbine engine with deflection limiter for a combination turbine nozzle and shroud.

FIG. 2 is a longitudinal cross-sectional view illustration of a turbine section with the deflection limiter for the combination turbine nozzle and shroud illustrated in FIG. 1.

FIG. 2A is an enlarged longitudinal cross-sectional view illustration of a monolithic outer band segment and the shroud segment with a flange therebetween of the combination turbine nozzle and shroud illustrated in FIG. 2.

FIG. 3 is a forward looking aft perspective view illustration of a combination turbine nozzle and shroud segment illustrated in FIG. 2.

FIG. 4 is a circumferential looking perspective view illustration of the combination turbine nozzle and shroud segment illustrated in FIG. 3.

FIG. 5 is a forward looking aft partially cutaway perspective view illustration of deflection limiters in the combination turbine nozzle and shroud segment illustrated in FIG. 3 surrounded by a casing.

FIG. 6 is a forward looking aft partially cutaway perspective view illustration of clocking means between the casing and the combination turbine nozzle and shroud segment illustrated in FIG. 3.

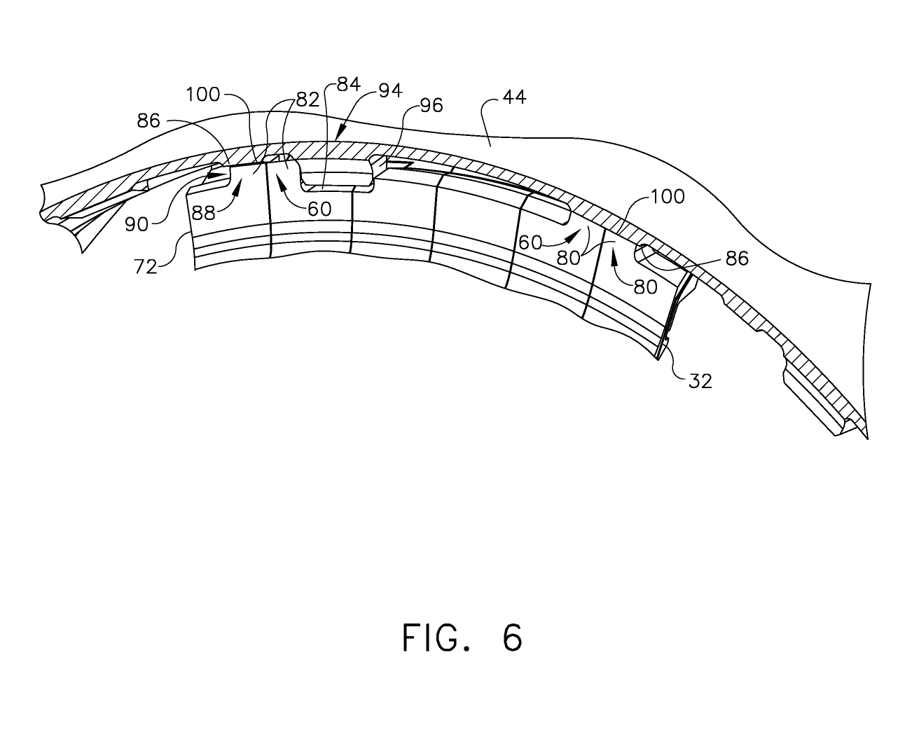

### DETAILED DESCRIPTION OF THE INVENTION

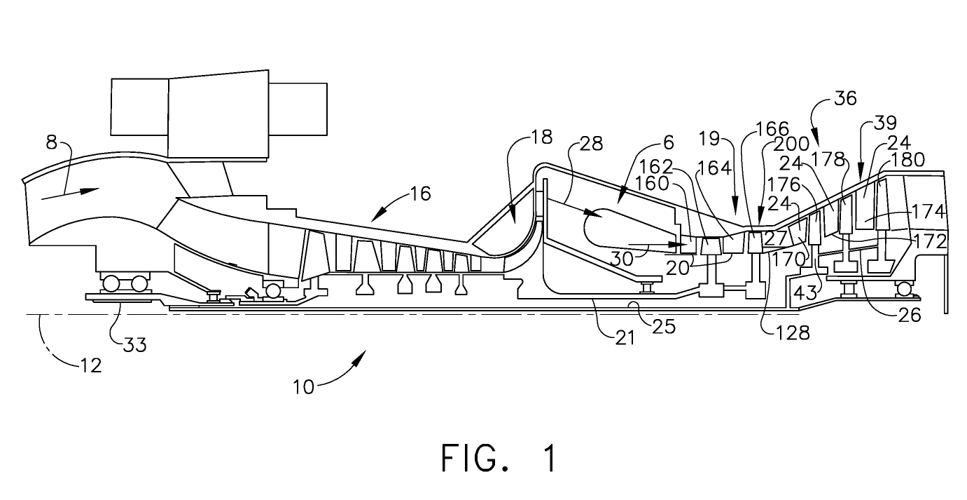

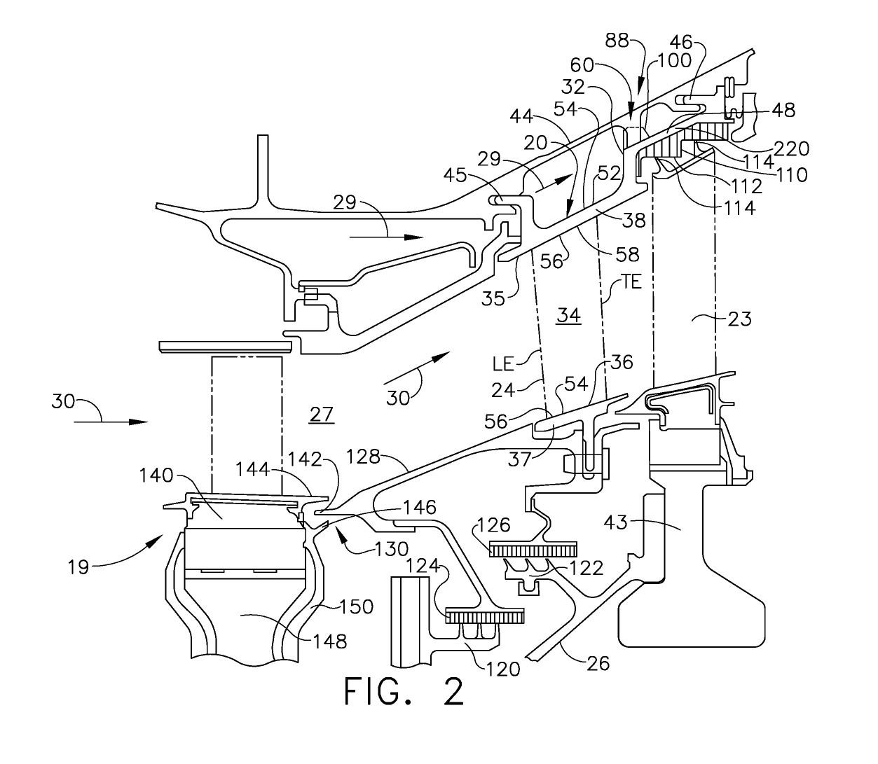

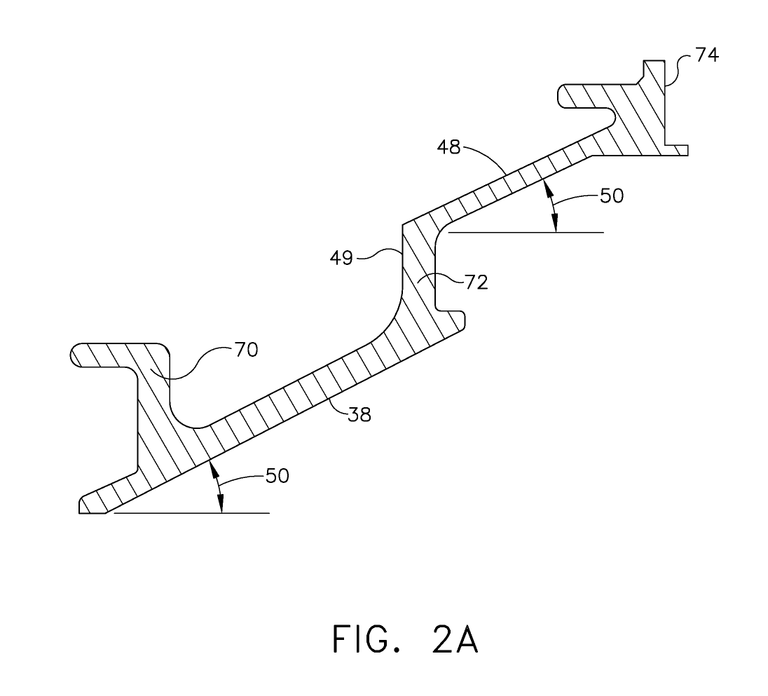

Illustrated schematically in FIG. 1 is an exemplary aircraft gas turbine engine 10 circumscribed about a longitudinal or axial centerline axis 12. Referring to FIGS. 1 and 2, the engine 10 includes, in downstream serial flow communication, a multistage axial high pressure compressor 16, a single stage centrifugal compressor 18, an annular combustor 6, a high pressure turbine 19, and a low pressure turbine 39. The high pressure turbine 19 includes, in downstream serial flow communication, a first stage high pressure turbine nozzle 160, first stage high pressure turbine blades 162, second stage high pressure turbine nozzle 164, and second stage high pressure turbine blades 166. The low pressure turbine 39 includes three stages of low pressure turbine nozzles 24, more specifically denoted as first, second, and third stage low pressure turbine nozzles 170, 172, 174. The low pressure turbine 39 includes three stages of low pressure turbine blades 23, more specifically denoted as first, second, and third stage low pressure turbine blades 176, 178, 180. The high pressure turbine 19, including first and second stage high pressure turbine blades 162, 166, is joined to the compressor 16 by a high pressure shaft 21. A power output shaft 33 is joined to the low pressure turbine rotor 26 by a low pressure shaft 25 coaxial with high pressure shaft 21. During operation, ambient air 8 flows downstream through the compressor 16 from where it exits as compressed air 28 and is then flowed into the combustor 6. The compressed air 28 is mixed with fuel and ignited in the combustor 6 generating hot combustion gases 30 which flow downstream through the high and low pressure turbines 19, 39 which extract energy therefrom for powering both the compressor 16 and the power output shaft 33 respectively.

Referring to FIGS. 1 and 2, various stator and rotor annular turbine components 200 of the turbines downstream from the combustor 6 define a turbine flowpath 27 which channels the hot combustion gases 30 therethrough for discharge from the engine. Downstream of and adjacent to the first stage low pressure turbine nozzle 170 are the first stage low pressure turbine blades 176 of the low pressure turbine rotor 26. The circumferentially spaced apart first stage low pressure turbine blades 176 extend radially outwardly from a low pressure turbine rotor disk 43 of the low pressure turbine rotor 26 and are used for extracting energy from the gases 30 and powering the power output shaft 33. A portion of the compressed air 28 is bled from the compressor 16 to provide bleed air which can be used as cooling air 29 which is channeled to various parts of the turbines such as the high and low pressure turbine nozzles 20, 24 to provide cooling thereof. The cooling air 29 is channeled around and through the low pressure turbine nozzle 24 at a substantially higher pressure than that of the combustion gases 30 flowing therethrough during operation.

Turbine stator components such as low pressure turbine nozzles and shrouds are often manufactured in arcuate segments and then assembled together in the engine 10 forming the turbine components. Various joints or gaps are provided between annular assemblies of arcuate segments which must be suitably sealed for preventing leakage of the high pressure cooling air 29 into the turbine flowpath 27. An annular turbine nozzle assembly 32 includes a circular row of circumferentially adjacent turbine nozzle segments 40 having outer bands 35 integral, monolithic, and integrally formed with shroud segments 48 that eliminates these joints or gaps as further illustrated in FIG. 2A.

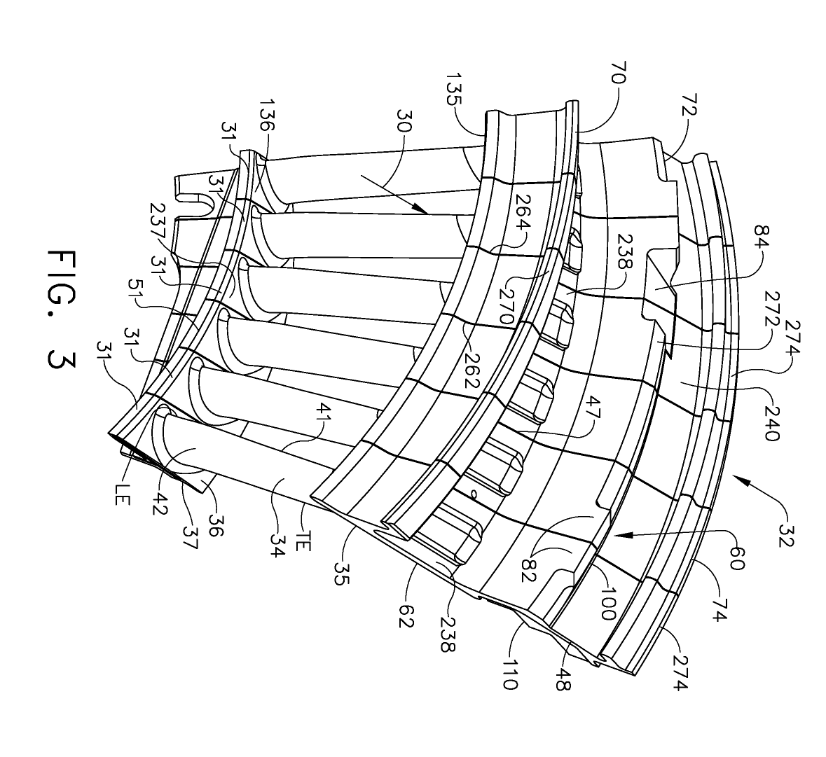

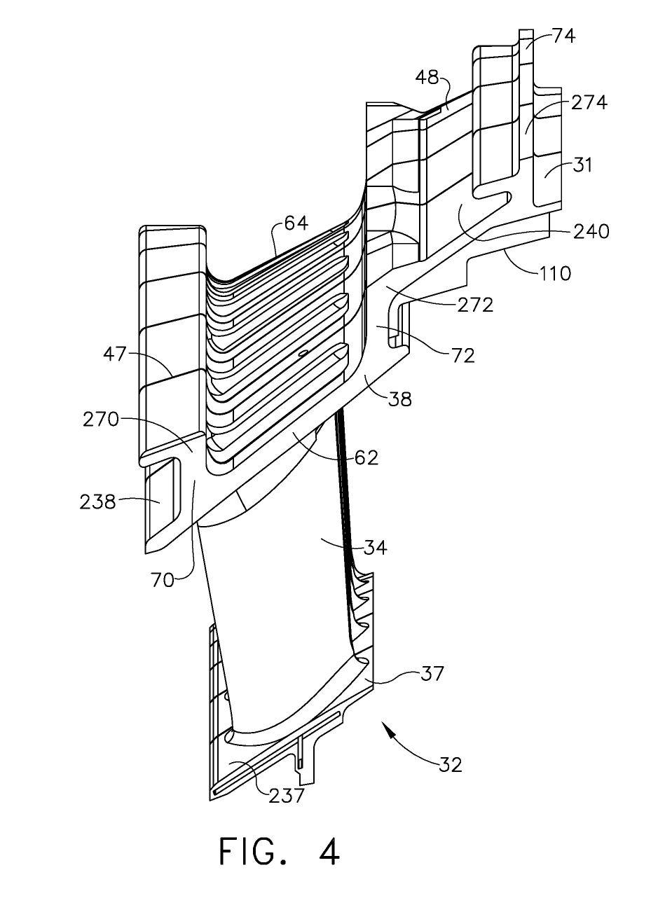

An exemplary embodiment of such a turbine nozzle segment 40 is further illustrated for the first low pressure turbine nozzle 24 in FIGS. 2, 2A, 3, and 4. The turbine nozzle segment 40 is surrounded by and supported from an annular outer casing 44 using forward and aft hooks 45, 46 as illustrated in FIG. 2. Illustrated in FIGS. 2 and 3 is an exemplary embodiment of the combination turbine nozzle segment 40 in the annular low pressure turbine nozzle 24. Each of the turbine nozzle segment 40 includes airfoils 34 extending between an annular segmented radially outer band 35 and a coaxial annular segmented radially inner band 36. The outer and inner bands 35, 36 bound the turbine flowpath 27 in the low pressure turbine nozzle 24. The airfoils 34 extend radially between and are fixedly joined to the outer and inner bands 35, 36. Pressure and suction sides 41, 42 of the airfoils 34 extend downstream from a leading edge LE to a trailing edge TE of each of the stator airfoils 34.

Referring to FIGS. 2, 2A, 3, and 4, circumferentially adjoining turbine nozzle assemblies 32 form the full 360 degree annular low pressure turbine nozzle 24 and shroud 220. The turbine nozzle assemblies 32 may be made from one, two, or more vanes or airfoils 34. Each of the exemplary turbine nozzle assemblies 32 includes one or more of the airfoils 34 extending radially between annular inner and outer band segments 37, 38. The outer band segment 38 extends axially between arcuate forward and middle outer flanges 70, 72. The forward and middle outer flanges 70, 72 extend radially outwardly from the outer band segment 38 and extend circumferentially between circumferentially spaced apart first and second edges 62, 64 of the outer band segment 38.

Each of the turbine nozzle assemblies 32 further includes a shroud segment 40 extending aft and downstream from a radially outer end 49 of the middle outer flange 72 to an aft flange 74. The exemplary embodiments of the outer band segment 38 and the shroud segment 48 illustrated herein are conical having substantially equal cone angles 50 and are spaced radially apart. The shroud segment 48 is spaced radially outward of the outer band segment 38. The shroud 220 is made from a circular array of the shroud segments 48. An annular shroud seal land 110 (honeycomb) extends radially inwardly of the shroud 220 and is made from a circular array of seal land segments 112 bonded to the shroud segments 48. Knife edge blade seals 114 extending radially outwardly from the low pressure turbine blades 23 sealingly engage the annular shroud seal land 110 as illustrated in FIG. 2.

Referring to FIGS. 2, 2A, 3, and 4, the outer band segment 38, forward and middle outer flanges 70, 72, shroud segment 48, aft flange 74 are all integral, monolithic, and may be integrally formed such as by equiax, directionally solidified, or single crystal casting. The exemplary embodiment of the turbine nozzle assembly 32 illustrated herein is monolithic, integral, and may be formed by equiax, directionally solidified, or single crystal casting. Collectively, the radially inner and outer band segments 37, 38 of the turbine nozzle assemblies 32 form the fully circular segmented annular radially outer and inner bands 35, 36 respectively. The inner surface 135 of the outer band 35 and the outer surface 136 of the inner band 36 define portions of flowpath boundaries for the combustion gases 30 which are channeled downstream to the low pressure turbine blades 23.

Each turbine nozzle assembly 32 may be made from subassemblies 51 such as singlets 31 as illustrated herein in the exemplary embodiment of the assembly. Circumferentially adjacent singlets 31 in the turbine nozzle assembly 32 are joined together. The singlets 31 may be joined together by brazing, indicated by braze line 47. Each singlet 31 includes one of the airfoils 34 extending radially between arcuate inner and outer band singlet segments 237, 238. Note, that the subassemblies 51 may include two or more airfoils between the arcuate inner and outer band segments such as doublets having two airfoils or triplets having three airfoils. The outer band singlet segment 238 extends axially between arcuate forward and middle outer singlet flanges 270, 272 which extend radially outwardly from the outer band singlet segment 238. The singlet 31 further includes a shroud singlet segment 240 extending aft and downstream from a radially outer end 49 of the middle outer singlet flange 272 to an aft singlet flange 274. The exemplary embodiments of the outer band singlet segment 238 and the shroud singlet segment 240 illustrated herein are conical having substantially equal cone angles 50 and are spaced radially apart. The forward and middle outer singlet flanges 270, 272 and the aft singlet flange 274 extend circumferentially between circumferentially spaced apart first and second singlet edges 262, 264 of the singlet 31.

The cooling air 29 is at a higher pressure compared to that of the combustion gases 30 flowing through the low pressure turbine nozzle 24. The relatively cold cooling air 29 cools the outer band segment 38 and the forward and middle outer flanges 70, 72 attached thereto. The relatively hot combustion gases 30 in the turbine flowpath 27 produce a hot surface 56 along an inner side 58 of the outer band segment 38. The inner band segment 37 has a cold surface 52 along an inner side 58 of the inner band segment 37. The relatively hot combustion gases 30 in the turbine flowpath 27 produce a hot surface 56 along a radially outer side 54 of the inner band segment 37.

Chording of all the outer band segments 38 in the entire outer band 35 including the forward and middle outer flanges 70, 72 occurs due to a thermal gradient associated with the hot combustion gases 30. The hot combustion gases 30 impart high temperatures to the flowpath side of the outer band 35 including the outer band segments 38 and the forward and middle outer flanges 70, 72. The cooling air 29 imparts cold temperatures on the outer surfaces of the outer band including the outer band segment 38 and the forward and middle outer flanges 70, 72. The thermal gradient is also due to conduction between the outer casing 44 and the turbine nozzle assembly 32 which occurs at the forward and aft hooks 45, 46. The temperature gradient is exacerbated by the flanges radial height resulting in a higher thermal gradient.

The first low pressure turbine nozzles 24 experience high stresses at the interface between the airfoils 34 and the band segments, particularly at trailing edges TE of the airfoils 34. The high stress results in cracking at these locations. One of the highest contributors to this stress is the chording, particularly of the flanges. As the band undergoes chording (bowing away from the flowpath), the airfoils are pulled on, resulting in high stresses.

The turbine nozzle assembly 32 includes a deflection limiting means 60 for counteracting chording or flattening. The deflection limiting means 60 illustrated herein includes one or more deflection limiters 100 extending radially outwardly from the outer band 35 or more particularly from at least one of the outer band segments 38 for limiting amount of axial excursion at the inner band 36 or the inner band segments 37. One embodiment of the deflection limiting means 60 illustrated herein are deflection limiters 100 on each middle outer flange 72. Two deflection limiters 100 are on each middle outer flange 72 of the exemplary embodiment of the turbine nozzle assembly 32 illustrated herein. The deflection limiters 100 limit the amount of radial excursion at the outer band 35 which in turn limit the amount of axial excursion at the inner band 36 and the inner band segments 37. Referring to FIG. 2, forward and aft knife edge rotor seals 120, 122 extend radially outwardly from the low pressure turbine rotor 26 and sealingly engage annular forward and aft rotor seal lands 124, 126 respectively. The forward and aft rotor seal lands 124, 126 are supported by an inner turbine duct 128 which in turn is supported by the inner band segments 37. Limiting the amount of axial excursion at the inner band 36 and the inner band segments 37 helps maintain proper sealing between the forward and aft knife edge rotor seals 120, 122 and the honeycomb backed forward and aft rotor seal lands 124, 126 by preventing the honeycomb from running into the rotating knife edge seals.

A radially inner angel wing seal assembly 130 provides sealing between the inner turbine duct 128 and a high pressure turbine disk 148 or rotor of the high pressure turbine 19 upon which high pressure turbine blades 140 are mounted. The angel wing seal assembly 130 is a discourager seal and includes an annular seal land 142 extending forwardly or upstream from the inner turbine duct 128. The seal land 142 is radially disposed in sealing relationship with and between aftwardly or downstream extending radially outer and inner angel wings 144, 146 attached to the high pressure turbine disk 148 or rotor. The inner angel wing 146 may be on an annular cooling plate 150 attached to the high pressure turbine disk 148 or rotor upon which the high pressure turbine blades 140 are mounted. The deflection limiters 100 limit the amount of axial excursion at the inner band 36 and the inner band segments 37 and limits or prevents interference with between the inner turbine duct 128 and the high pressure turbine disk 148 or rotor and the high pressure turbine blades 140. The deflection limiters 100 also limits the inner turbine duct 128 and the high pressure turbine disk 148 from coming to far apart which would allow hot gas to flow into the cavity located radially inward of the turbine flowpath 27 and heat up the high pressure turbine disk 148 potentially leading to failure.

The exemplary embodiment of the deflection limiters 100 disclosed herein include outward projections 80 extending upwardly or radially outwardly from the middle outer flange 72. The outward projections 80 may be made from two circumferentially adjacent outward complimentary portions 82 on the two circumferentially adjacent singlets 31 in the turbine nozzle assembly 32 as illustrated in FIGS. 3-5. The exemplary embodiment of the casing 44 disclosed herein includes inward projections 86 extending inwardly or radially inwardly from the casing 44 at or about the same axial and circumferential locations 88, 90 of the outward projections 80. The outward projections 80 will contact the inward projections 86 during chording of the middle outer flange 72.

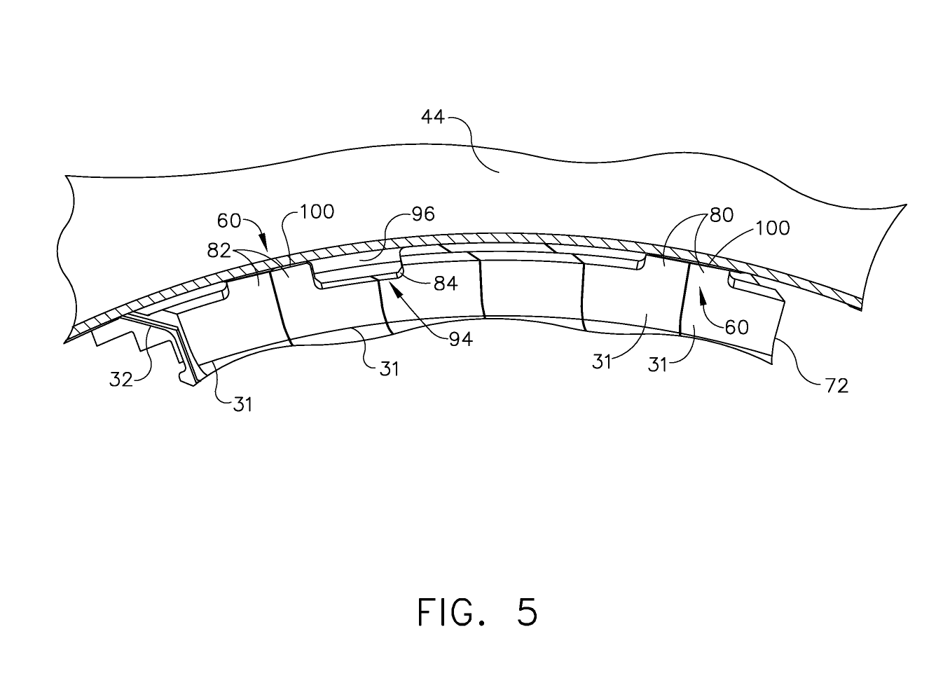

FIG. 5 illustrates a clocking means 94 which sets and maintains the circumferential orientation of the turbine nozzle assembly 32 with respect to the casing 44. An exemplary embodiment of the clocking means 94 illustrated herein includes an inwardly extending low pressure turbine casing anti-rotation tab 96 axially and circumferentially disposed and trapped in a clocking slot 84, also illustrated in FIG. 3, in the middle outer flange 72 of the turbine nozzle assembly 32. The clocking slot 84 may be angled radially inwardly from the outer band segment 38 through the middle outer flange 72. The clocking slot 84 may be disposed across two circumferentially adjacent singlets 31 as illustrated in FIGS. 3 and 5.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention. Accordingly, what is desired to be secured by Letters Patent of the United States is the invention as defined and differentiated in the following claims.

What is claimed:

1. A gas turbine engine annular turbine nozzle assembly:
airfoils extending between annular inner and outer band segments,
the inner and outer band segments being coaxial and circumscribed about a longitudinal or axial centerline axis,
a shroud segment extending aft and downstream away from the outer band segment, and
one or more deflection limiters extending radially outwardly from the outer band segment for limiting amount of axial excursion at the inner band segments.

2. The assembly as claimed in claim 1, further comprising:
an arcuate middle outer flange extending radially outwardly from the outer band segment,
the shroud segment extending aft and downstream from the middle outer flange, and
the one or more deflection limiters on the middle outer flange extending radially outwardly from the outer band segment for limiting the amount of axial excursion at the inner band segments.

3. The assembly as claimed in claim 1, further comprising the outer band segment and the shroud segment being integral, monolithic, and integrally formed.

4. The assembly as claimed in claim 3, further comprising the outer band segment and the shroud segment being integrally formed by equiax, directionally solidified, or single crystal casting.

5. The assembly as claimed in claim 1, further comprising the one or more deflection limiters including one or more outward projections respectively extending upwardly or radially outwardly from the outer band segment.

6. The assembly as claimed in claim 2, further comprising the shroud segment spaced radially apart from the outer band segment.

7. The assembly as claimed in claim 6, further comprising the outer band segment, the middle outer flange, and the shroud segment being integral, monolithic, and integrally formed.

8. The assembly as claimed in claim 7, further comprising the outer band segment, the middle outer flange, and the shroud segment being integrally formed by equiax, directionally solidified, or single crystal casting.

9. The assembly as claimed in claim 2, further comprising:
bonded together singlets,
each of the singlets including one of the airfoils extending radially between arcuate inner and outer band singlet segments,
the outer band singlet segment extending axially between arcuate forward and middle outer singlet flanges,
the forward and middle outer singlet flanges extending radially outwardly from the outer band singlet segment, and
the singlet including a shroud singlet segment extending aft and downstream from the outer band singlet segment to an aft singlet flange.

10. The assembly as claimed in claim 9, further comprising the singlets being integrally formed by equiax, directionally solidified, or single crystal casting.

11. The assembly as claimed in claim 2, further comprising:
bonded together singlets,
each of the singlets including one of the airfoils extending radially between arcuate inner and outer band singlet segments,
the outer band singlet segment extending axially between arcuate forward and middle outer singlet flanges,
the forward and middle outer singlet flanges extending radially outwardly from the outer band singlet segment,
the singlet including a shroud singlet segment extending aft and downstream from the outer band singlet segment to an aft singlet flange,
the one or more deflection limiters including one or more outward projections respectively extending upwardly or radially outwardly from the middle outer flange, and
each of the outward projections including two circumferentially adjacent outward complimentary portions on two circumferentially adjacent ones of the singlets.

12. The assembly as claimed in claim 11, further comprising the singlets being integrally formed by equiax, directionally solidified, or single crystal casting.

13. A gas turbine engine assembly:
a gas turbine engine annular turbine nozzle assembly including airfoils extending between annular inner and outer band segments,
an annular outer casing surrounding and supporting the gas turbine engine annular turbine nozzle assembly,
the inner and outer band segments being coaxial and circumscribed about a longitudinal or axial centerline axis,
a shroud segment extending aft and downstream away from the outer band segment, and
one or more deflection limiters extending radially outwardly from the outer band segment for limiting amount of axial excursion at the inner band segments.

14. The assembly as claimed in claim 13, further comprising:
an arcuate middle outer flange extending radially outwardly from the outer band segment,
the shroud segment extending aft and downstream from the middle outer flange, and
the one or more deflection limiters on the middle outer flange extending radially outwardly from the outer band segment for limiting the amount of axial excursion at the inner band segments.

15. The assembly as claimed in claim 14, further comprising the outer band segment, the middle outer flange, and the shroud segment being integral, monolithic, and/or integrally formed by equiax, directionally solidified, or single crystal casting.

16. The assembly as claimed in claim 15, further comprising the shroud segment spaced radially apart from the outer band segment.

17. The assembly as claimed in claim 14, further comprising:
the combination turbine nozzle and shroud segment including bonded together singlets,
each of the singlets including one of the airfoils extending radially between arcuate inner and outer band singlet segments,
the outer band singlet segment extending axially between arcuate forward and middle outer singlet flanges,
the forward and middle outer singlet flanges extending radially outwardly from the outer band singlet segment, and
the singlet including a shroud singlet segment extending aft and downstream from the outer band singlet segment to an aft singlet flange.

18. The assembly as claimed in claim 17, further comprising the singlets being integrally formed by equiax, directionally solidified, or single crystal casting.

19. The assembly as claimed in claim 14, further comprising inward projections extending inwardly or radially inwardly from the casing at or about at axial and circumferential locations of the deflection limiters.

20. The assembly as claimed in claim 19 further comprising the one or more deflection limiters including one or more outward projections respectively extending upwardly or radially outwardly from the middle outer flange.

21. The assembly as claimed in claim 19 further comprising:
a radially inner discourager or angel wing seal sealingly disposed between an inner turbine duct and a high pressure turbine disk or rotor of the high pressure turbine upon which high pressure turbine blades are mounted,
the inner turbine duct attached to the combination turbine nozzle and shroud segment,
the discourager or angel wing seal including an annular seal land extending aftwardly or upstream from the inner turbine duct, and
the seal land radially disposed between and in sealing relationship with aftwardly or downstream extending radially outer and inner angel wings attached to the high pressure turbine disk or rotor.

22. The assembly as claimed in claim 21 further comprising the one or more deflection limiters including one or more outward projections respectively extending upwardly or radially outwardly from the middle outer flange.

23. The assembly as claimed in claim 22 further comprising the inner angel wing on an annular cooling plate attached to the high pressure turbine disk.

24. The assembly as claimed in claim 22, further comprising:
the gas turbine engine annular turbine nozzle assembly including bonded together singlets,
each of the singlets including one of the airfoils extending radially between arcuate inner and outer band singlet segments,
the outer band singlet segment extending axially between arcuate forward and middle outer singlet flanges,
the forward and middle outer singlet flanges extending radially outwardly from the outer band singlet segment, and
the singlet including a shroud singlet segment extending aft and downstream from the outer band singlet segment to an aft singlet flange.

25. The assembly as claimed in claim 24, further comprising the singlets being integrally formed by equiax, directionally solidified, or single crystal casting.
